(19) United States
(12) Patent Application Publication
(10) Pub. No.: US 2024/0020802 A1
(43) Pub. Date: Jan. 18, 2024

(54) Storage And Signaling Of Entrance Pupil And Distortion Parameters In Image File Format

(71) Applicant: Nokia Technologies Oy, Espoo (FI)

(72) Inventors: Peter Oluwanisola Fasogbon, Tampere (FI); Kashyap Kammachi Sreedhar, Tampere (FI); Miska Matias Hannuksela, Tampere (FI); Emre Baris Aksu, Tampere (FI)

(21) Appl. No.: 18/219,173

(22) Filed: Jul. 7, 2023

Related U.S. Application Data
(60) Provisional application No. 63/388,447, filed on Jul. 12, 2022.

(51) Int. Cl. G06T 5/00; G06T 7/80

(52) U.S. Cl. CPC G06T 5/006; G06T 7/80

(57) ABSTRACT

An apparatus may be configured to: determine at least one image; determine at least one camera parameter; determine at least one distortion parameter, wherein the at least one distortion parameter comprises at least one entrance pupil parameter; determine at least one control point of the at least one image; and refine the at least one distortion parameter based, at least partially, on the at least one control point and the at least one camera parameter.

### TECHNICAL FIELD

The example and non-limiting embodiments relate generally to camera model calibration and, more particularly, to distortion correction.

### BACKGROUND

It is known, in image processing, to calibrate a camera model.

### SUMMARY

The following summary is merely intended to be illustrative. The summary is not intended to limit the scope of the claims.

In accordance with one aspect, an apparatus comprising: at least one processor; and at least one memory including computer program code; the at least one memory and the computer program code configured to, with the at least one processor, cause the apparatus at least to: determine at least one image; determine at least one camera parameter; determine at least one distortion parameter, wherein the at least one distortion parameter comprises at least one entrance pupil parameter; determine at least one control point of the at least one image; and refine the at least one distortion parameter based, at least partially, on the at least one control point and the at least one camera parameter.

In accordance with one aspect, a method comprising: determining, with a device, at least one image; determining at least one camera parameter; determining at least one distortion parameter, wherein the at least one distortion parameter comprises at least one entrance pupil parameter; determining at least one control point of the at least one image; and refining the at least one distortion parameter based, at least partially, on the at least one control point and the at least one camera parameter.

In accordance with one aspect, an apparatus comprising means for performing: determining at least one image; determining at least one camera parameter; determining at least one distortion parameter, wherein the at least one distortion parameter comprises at least one entrance pupil parameter; determining at least one control point of the at least one image; and refining the at least one distortion parameter based, at least partially, on the at least one control point and the at least one camera parameter.

In accordance with one aspect, a non-transitory computer-readable medium comprising program instructions stored thereon which, when executed with at least one processor, cause the at least one processor to: determine at least one image; determine at least one camera parameter; determine at least one distortion parameter, wherein the at least one distortion parameter comprises at least one entrance pupil parameter; determine at least one control point of the at least one image; and cause refining of the at least one distortion parameter based, at least partially, on the at least one control point and the at least one camera parameter.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a block diagram of one possible and non-limiting exemplary system in which the exemplary embodiments may be practiced;

FIG. 3 is a diagram illustrating features as described herein; and

FIG. 4 is a flowchart illustrating steps as described herein.

### DETAILED DESCRIPTION OF EMBODIMENTS

The following abbreviations that may be found in the specification and/or the drawing figures are defined as follows:
3GPP third generation partnership project
4G fourth generation
5G fifth generation
5G core network
AR augmented reality
AVC Advanced Video Coding
CDMA code division multiple access
CPU central processing unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
EP entrance pupil
E-UTRA evolved universal terrestrial radio access, i.e., the LTE radio access technology
FDMA frequency division multiple access
gNB (or gNodeB) base station for 5G/NR, i.e., a node providing NR user plane and control plane protocol terminations towards the UE, and connected via the NG interface to the 5GC
GPU graphical processing unit
GSM global systems for mobile communications
HEIF high efficiency image file format
HEVC High Efficiency Video Coding
HMD head-mounted display
IEEE Institute of Electrical and Electronics Engineers
IMD integrated messaging device
IMS instant messaging service
IoT Internet of Things
ISO International Standards Organization
ISOBMMF International Standards Organization base media file format
LTE long term evolution
MMS multimedia messaging service
MPEG-I Moving Picture Experts Group immersive codec family
MR mixed reality
ng or NG new generation
ng-eNB or NG-eNB new generation eNB
NSVP non-single viewpoint
NR new radio
PC personal computer
PDA personal digital assistant
SMS short messaging service
SVP single viewpoint
TCP-IP transmission control protocol-Internet protocol
TDMA time division multiple access
UE user equipment (e.g., a wireless, typically mobile device)
UMTS universal mobile telecommunications system
USB universal serial bus
VR virtual reality
VVC Versatile Video Coding
WLAN wireless local area network

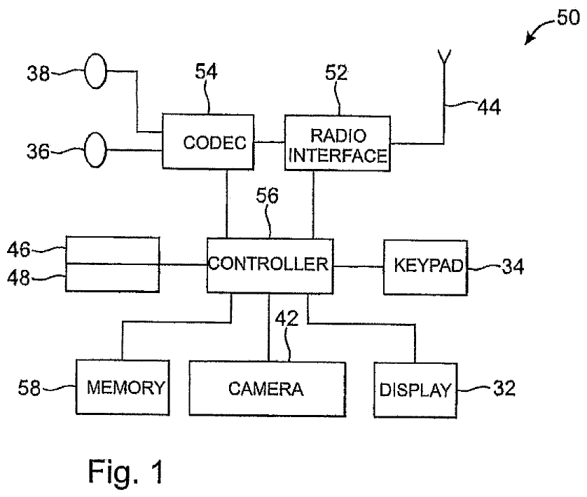

The following describes suitable apparatus and possible mechanisms for practicing example embodiments of the present disclosure. Accordingly, reference is first made to FIG. 1, which shows an example block diagram of an apparatus 50. The apparatus may be configured to perform various functions such as, for example, gathering information by one or more sensors, encoding and/or decoding information, receiving and/or transmitting information, analyzing information gathered or received by the apparatus, or the like. A device configured to encode a video scene may (optionally) comprise one or more microphones for capturing the scene and/or one or more sensors, such as cameras, for capturing information about the physical environment in which the scene is captured. Alternatively, a device configured to encode a video scene may be configured to receive information about an environment in which a scene is captured and/or a simulated environment. A device configured to decode and/or render the video scene may be configured to receive a Moving Picture Experts Group immersive codec family (MPEG-I) bitstream comprising the encoded video scene. A device configured to decode and/or render the video scene may comprise one or more speakers/audio transducers and/or displays, and/or may be configured to transmit a decoded scene or signals to a device comprising one or more speakers/audio transducers and/or displays. A device configured to decode and/or render the video scene may comprise a user equipment, a head/mounted display, or another device capable of rendering to a user an AR, VR and/or MR experience.

The electronic device 50 may for example be a mobile terminal or user equipment of a wireless communication system. Alternatively, the electronic device may be a computer or part of a computer that is not mobile. It should be appreciated that embodiments of the present disclosure may be implemented within any electronic device or apparatus which may process data. The electronic device 50 may comprise a device that can access a network and/or cloud through a wired or wireless connection. The electronic device 50 may comprise one or more processors 56, one or more memories 58, and one or more transceivers 52 interconnected through one or more buses. The one or more processors 56 may comprise a central processing unit (CPU) and/or a graphical processing unit (GPU). Each of the one or more transceivers 52 includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers may be connected to one or more antennas 44. The one or more memories 58 may include computer program code. The one or more memories 58 and the computer program code may be configured to, with the one or more processors 56, cause the electronic device 50 to perform one or more of the operations as described herein.

The electronic device 50 may connect to a node of a network. The network node may comprise one or more processors, one or more memories, and one or more transceivers interconnected through one or more buses. Each of the one or more transceivers includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers may be connected to one or more antennas. The one or more memories may include computer program code. The one or more memories and the computer program code may be configured to, with the one or more processors, cause the network node to perform one or more of the operations as described herein.

The electronic device 50 may comprise a microphone 36 or any suitable audio input which may be a digital or analogue signal input. The electronic device 50 may further comprise an audio output device 38 which in embodiments of the present disclosure may be any one of: an earpiece, speaker, or an analogue audio or digital audio output connection. The electronic device 50 may also comprise a battery (or in other embodiments of the present disclosure the device may be powered by any suitable mobile energy device such as solar cell, fuel cell, or clockwork generator). The electronic device 50 may further comprise a camera 42 or other sensor capable of recording or capturing images and/or video. Additionally or alternatively, the electronic device 50 may further comprise a depth sensor. The electronic device 50 may further comprise a display 32. The electronic device 50 may further comprise an infrared port for short range line of sight communication to other devices. In other embodiments the apparatus 50 may further comprise any suitable short-range communication solution such as for example a BLUETOOTH™ wireless connection or a USB/firewire wired connection.

It should be understood that an electronic device 50 configured to perform example embodiments of the present disclosure may have fewer and/or additional components, which may correspond to what processes the electronic device 50 is configured to perform. For example, an apparatus configured to encode a video might not comprise a speaker or audio transducer and may comprise a microphone, while an apparatus configured to render the decoded video might not comprise a microphone and may comprise a speaker or audio transducer.

Referring now to FIG. 1, the electronic device 50 may comprise a controller 56, processor or processor circuitry for controlling the apparatus 50. The controller 56 may be connected to memory 58 which in embodiments of the present disclosure may store both data in the form of image and audio data and/or may also store instructions for implementation on the controller 56. The controller 56 may further be connected to codec circuitry 54 suitable for carrying out coding and/or decoding of audio and/or video data or assisting in coding and/or decoding carried out by the controller.

The electronic device 50 may further comprise a card reader 48 and a smart card 46, for example a UICC and UICC reader, for providing user information and being suitable for providing authentication information for authentication and authorization of the user/electronic device 50 at a network. The electronic device may further comprise an input device 34, such as a keypad, one or more input buttons, or a touch screen input device, for providing information to the controller 56.

The electronic device 50 may comprise radio interface circuitry 52 connected to the controller and suitable for generating wireless communication signals for example for communication with a cellular communications network, a wireless communications system, or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The electronic device 50 may comprise a microphone 38, camera 42, and/or other sensors capable of recording or detecting audio signals, image/video signals, and/or other information about the local/virtual environment, which are then passed to the codec 54 or the controller 56 for processing. The electronic device 50 may receive the audio/image/video signals and/or information about the local/virtual environment for processing from another device prior to transmission and/or storage. The electronic device 50 may also receive either wirelessly or by a wired connection the audio/image/video signals and/or information about the local/virtual environment for encoding/decoding. The structural elements of electronic device 50 described above represent examples of means for performing a corresponding function.

The memory 58 may be of any type suitable to the local technical environment and may be implemented using any suitable data storage technology, such as semiconductor-based memory devices, flash memory, magnetic memory devices and systems, optical memory devices and systems, fixed memory and removable memory. The memory 58 may be a non-transitory memory. The memory 58 may be means for performing storage functions. The controller 56 may be or comprise one or more processors, which may be of any type suitable to the local technical environment, and may include one or more of general-purpose computers, special purpose computers, microprocessors, digital signal processors (DSPs) and processors based on a multi-core processor architecture, as non-limiting examples. The controller 56 may be means for performing functions.

The electronic device 50 may be configured to perform capture of a volumetric scene according to example embodiments of the present disclosure. For example, the electronic device 50 may comprise a camera 42 or other sensor capable of recording or capturing images and/or video. The electronic device 50 may also comprise one or more transceivers 52 to enable transmission of captured content for processing at another device. Such an electronic device 50 may or may not include all the modules illustrated in FIG. 1.

The electronic device 50 may be configured to perform processing of volumetric video content according to example embodiments of the present disclosure. For example, the electronic device 50 may comprise a controller 56 for processing images to produce volumetric video content, a controller 56 for processing volumetric video content to project 3D information into 2D information, patches, and auxiliary information, and/or a codec 54 for encoding 2D information, patches, and auxiliary information into a bitstream for transmission to another device with radio interface 52. Such an electronic device 50 may or may not include all the modules illustrated in FIG. 1.

The electronic device 50 may be configured to perform encoding or decoding of 2D information representative of volumetric video content according to example embodiments of the present disclosure. For example, the electronic device 50 may comprise a codec 54 for encoding or decoding 2D information representative of volumetric video content. Such an electronic device 50 may or may not include all the modules illustrated in FIG. 1.

The electronic device 50 may be configured to perform rendering of decoded 3D volumetric video according to example embodiments of the present disclosure. For example, the electronic device 50 may comprise a controller for projecting 2D information to reconstruct 3D volumetric video, and/or a display 32 for rendering decoded 3D volumetric video. Such an electronic device 50 may or may not include all the modules illustrated in FIG. 1.

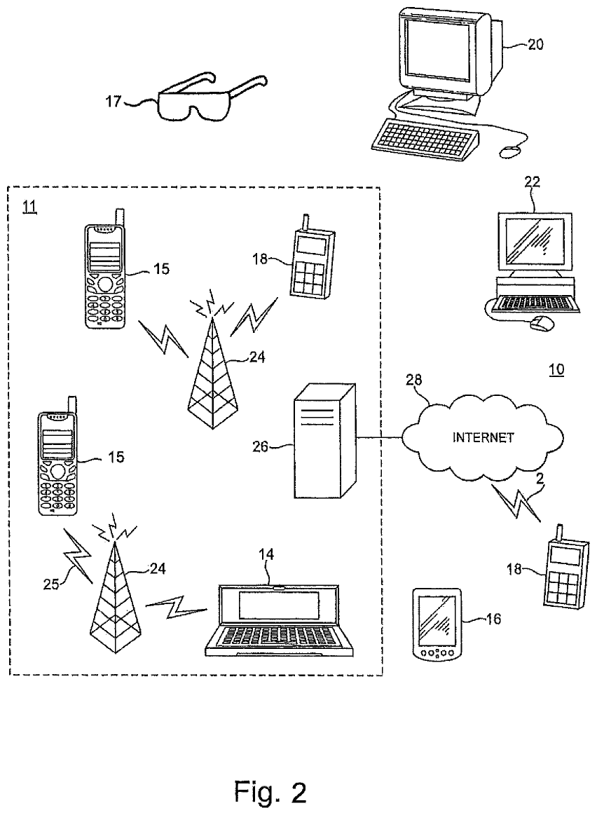

With respect to FIG. 2, an example of a system within which embodiments of the present disclosure can be utilized is shown. The system 10 comprises multiple communication devices which can communicate through one or more networks. The system 10 may comprise any combination of wired or wireless networks including, but not limited to a wireless cellular telephone network (such as a GSM, UMTS, E-UTRA, LTE, CDMA, 4G, 5G network etc.), a wireless local area network (WLAN) such as defined by any of the IEEE 802.x standards, a BLUETOOTH™ personal area network, an Ethernet local area network, a token ring local area network, a wide area network, and/or the Internet.

The system 10 may include both wired and wireless communication devices and/or electronic devices suitable for implementing embodiments of the present disclosure.

For example, the system shown in FIG. 2 shows a mobile telephone network 11 and a representation of the Internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an apparatus 15, a combination of a personal digital assistant (PDA) and a mobile telephone 14, a PDA 16, an integrated messaging device (IMD) 18, a desktop computer 20, a notebook computer 22, and a head-mounted display (HMD) 17. The electronic device 50 may comprise any of those example communication devices. In an example embodiment of the present disclosure, more than one of these devices, or a plurality of one or more of these devices, may perform the disclosed process(es). These devices may connect to the internet 28 through a wireless connection 2.

The embodiments may also be implemented in a set-top box; i.e. a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding. The embodiments may also be implemented in cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Some or further apparatus may send and receive calls and messages and communicate with service providers through a wireless connection 25 to a base station 24, which may be, for example, an eNB, gNB, etc. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), BLUETOOTH′, IEEE 802.11, 3GPP Narrowband IoT and any similar wireless communication technology. A communications device involved in implementing various embodiments of the present disclosure may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, which may be a MPEG-I bitstream, from one or several senders (or transmitters) to one or several receivers.

Having thus introduced one suitable but non-limiting technical context for the practice of the example embodiments of the present disclosure, example embodiments will now be described with greater specificity.

Available media file format standards include International Standards Organization (ISO) base media file format (ISO/IEC 14496-12, which may be abbreviated ISOBMFF).

Some concepts, structures, and specifications of ISOBMFF are described below as an example of a container file format, based on which some embodiments may be implemented. The features of the disclosure are not limited to ISOBMFF, but rather the description is given for one possible basis on top of which at least some embodiments may be partly or fully realized.

A basic building block in the ISO base media file format is called a box. Each box has a header and a payload. The box header indicates the type of the box and the size of the box in terms of bytes. A box type is typically identified by an unsigned 32-bit integer, interpreted as a four character code (4 CC or 4 cc). A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

Files conforming to the ISOBMFF may contain any non-timed objects, referred to as items, meta items, or metadata items, in a meta box (four-character code: ‘meta’). While the name of the meta box refers to metadata, items can generally contain metadata or media data. The meta box may reside at the top level of the file, within a movie box (four-character code: ‘moov’), and within a track box (four-character code: ‘trak’), but at most one meta box may occur at each of the file level, movie level, or track level. The meta box may be required to contain a ‘hdlr’ box indicating the structure or format of the ‘meta’ box contents. The meta box may list and characterize any number of items that can be referred, and each one of them can be associated with a file name and are uniquely identified with the file by item identifier (item id) which is an integer value. The metadata items may be for example stored in the ‘idat’ box of the meta box or in an ‘mdat’ box or reside in a separate file. When the metadata is located external to the file, its location may be declared by the DataInformationBox (four-character code: ‘dinf’). In the specific case that the metadata is formatted using eXtensible Markup Language (XML) syntax and is required to be stored directly in the MetaBox, the metadata may be encapsulated into either the XMLBox (four-character code: ‘xml’) or the BinaryXMLBox (four-character code: ‘bxml’). An item may be stored as a contiguous byte range, or it may be stored in several extents, each being a contiguous byte range. In other words, items may be stored fragmented into extents, e.g., to enable interleaving. An extent is a contiguous subset of the bytes of the resource. The resource can be formed by concatenating the extents.

The ItemPropertiesBox enables the association of any item with an ordered set of item properties. Item properties may be regarded as small data records. The ItemPropertiesBox consists of two parts: ItemPropertyContainerBox that contains an implicitly indexed list of item properties, and one or more ItemPropertyAssociationBox(es) that associate items with item properties.

High Efficiency Image File Format (HEIF, ISO/IEC 23008-12) is a standard originally developed by the Moving Picture Experts Group (MPEG) for storage of images and image sequences. Among other things, the standard facilitates file encapsulation of data coded according to the Advanced Video Coding (AVC) standard, the High Efficiency Video Coding (HEVC) standard, or the Versatile Video Coding (VVC) standard. HEIF includes features building on top of the used ISO Base Media File Format (ISOBMFF).

The ISOBMFF structures and features are used to a large extent in the design of HEIF. The basic design for HEIF comprises still images that are stored as items and image sequences that are stored as tracks.

In the context of HEIF, the following boxes may be included within the root-level ‘meta’ box and may be used as described in the following. In HEIF, the handler value of the Handler box of the ‘meta’ box is ‘pict’. The resource (whether within the same file, or in an external file identified by a uniform resource identifier) including the coded media data is resolved through the data information (‘dinf’) box, whereas the item location (‘floc’) box stores the position and sizes of every item within the referenced file. The item reference (‘iref’) box documents relationships between items using typed referencing. When there is an item among a collection of items that is in some way to be considered the most important compared to others, then this item is signaled by the primary item (‘pitm’) box. Apart from the boxes mentioned here, the ‘meta’ box is also flexible to include other boxes that may be necessary to describe items.

Any number of image items can be included in the same file. Given a collection of images stored by using the ‘meta’ box approach, it sometimes is essential to qualify certain relationships between images. Examples of such relationships include indicating a cover image for a collection, providing thumbnail images for some or all of the images in the collection, and associating some or all of the images in a collection with an auxiliary image such as an alpha plane. A cover image among the collection of images is indicated using the ‘pitm’ box. A thumbnail image or an auxiliary image is linked to the primary image item using an item reference of type ‘thmb’ or ‘aux1’, respectively.

Features as described herein generally relate to the high efficiency image file format (HEIF) defined by ISO/IEC International Standard 23008-12. More specifically, features as described herein generally relate to enhancements to HEIF, for example storage and signaling of entrance pupil (EP) information, in addition to information related to optical/lens distortions that may be present in future HEIF images. In an example embodiment, distortions may be simplified; the simplification of distortions may be very important in advance image tasks operation, transformation, projections, overlays, manipulations, etc. (including but not limited to manipulations between different image formats from different camera models).

Camera calibration solves the mapping between 3D coordinates of viewer-observable points from the 3D real world, and their corresponding 2D image projection, using an optical imaging lens (e.g. camera). The parameters that define this mapping are usually divided into two categories: intrinsic parameters that depend on the internal characteristics of lens and sensors, and extrinsic parameters that depend on the relative position and orientation of the optical imaging lens in the 3D real world. These sets of parameters form the calibration set, and thus represent the used camera model. When the camera model is computed, it may be said that the camera is calibrated. As a result, any projection that involves the use of the calibrated camera needs this camera model for accurate transformation between 3D and 2D points.

The accuracy of a calibration method is evaluated using the reprojection error between the 3D coordinate and its image projection. Therefore, in an ideal scenario, the accurate calibration will ensure a zero reprojection error. However, this is not true in every case due to the presence of optical distortions such as, for example, entrance pupil, radial and tangential.

P. Fasogbon, E. Aksu, “CALIBRATION OF FISHEYE CAMERA USING ENTRANCE PUPIL”, IEEE ICIP, 2019 shows how to calibrate a fisheye camera using Entrance Pupil (EP) based on a generic model. The paper shows how the given EP coefficients may be added to image coordinates to create corrected image pixels. This may make it possible to transform distorted coordinates back and forth with entrance pupil coefficients for various image manipulation task. The image formation based on EP proposed in the paper is:

$$[ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ R T ] [ \begin{matrix}X \\ Y \\ Z + E ( θ ) \\ 1\end{matrix} ] \qquad ( 1 )$$

where E(θ) is the entrance pupil function. Rotation R and Translation T are extrinsic parameters, P(X,Y,Z) is a point in the world coordinate, u and v are image pixels, cₓ and c_{y} are principal points in pixels, and fₓ and f_{y} are focal lengths in the x and y-axes, respectively.

E(θ)=e1*θ₁³+e2*θ₁⁵+e3*θ₁⁷+e4*θ₁⁹+e5*θ₁¹¹ (2)

The image formation of equation 2 shows that we can directly translate the world plane on the Z axis to the correct entrance pupil shift. In “CALIBRATION OF FISHEYE CAMERA USING ENTRANCE PUPIL,” the author shows that, in practice, this translation can be done on the normalized camera coordinate by adding EP on the normalized Z axis, thanks to radial distance in the image plane. Indeed, the formulation has been intended so that EP parameters are part of the extrinsic parameter set, when intended for fisheye cameras.

However, recent needs in some specific applications may require that EP are modelled as part of the intrinsic parameter set. Such applications may include cases in which every lens distortion may be modeled, such as radial and tangential distortion together with entrance pupil distortion, in an end-to-end distortion removal procedure. As a result, it may be useful to extend, or simplify further, the EP formulation in equation (1). Example embodiments of the present disclosure may have the technical effect of manipulating the EP formulation proposed of equation (2) to fit into intrinsic representation.

It may be noted that there is currently no standardized way to store and signal entrance pupil parameters, nor any other form of lens distortion, in HEIF. However, such distortion information may be required for the media system manipulation. Example embodiments of the present disclosure may introduce distortion parameters into HEIF. Example embodiments of the present disclosure may illustrate how distortion may be simplified and/or removed (i.e. from images/pixels).

Image formation models for non-conventional and conventional camera have been described in the art. For fisheye cameras, there are two popular practical camera calibration methods, as described by Kannala [http://docs.opencv.org/3.1.0/dc/dbb/tutorial_py_calibration.html] and Scaramuzza OcamCalib library [https://sites.google.com/site/scarabotix/ocamcalib-toolbox]. Both of these methods use the assumption of single view point (SVP), and do not take into account EP shift. In Avinash Kumar, Narendra Ahuja, “Generalized Pupil-Centric Imaging and Analytical Calibration for a Non-frontal Camera”, Proc. IEEE Conference on Computer Vision and Pattern Recognition, pp. 3970-3977, 2014, a general camera model that includes entrance pupil variation and suitable for fisheye was introduced, but it is an extremely complex model with a high number of parameters. State of the art calibration methods put a lot of unnecessary burden on the optical lens model to simplify the distortions introduced because of the varying entrance pupil. This tends to affect the accuracy of the calibration, and proper estimation of the distortion parameters. Objects closer to the camera tends to be the most impacted by the entrance pupil variation. A new camera model based on varying entrance pupil has been proposed in P. Fasogbon, E. Aksu, “CALIBRATION OF FISHEYE CAMERA USING ENTRANCE PUPIL”, IEEE ICIP, 2019, as noted above, and EP correction is introduced to bring non-single viewpoint (NSVP) to SVP. The integration of this model to the omnidirectional media format (OMAF) is discussed in P. Fasogbon, E. Aksu, M. Hannuksela, “Storage and signaling of entrance pupil parameters for immersive media”, U.S. patent Ser. No. 11/336,812B2.

ISO/IEC 23008-12 2nd Edition, Committee Draft of Amendment 1 (CDAM1, MDS21461_WG03_N00568) documents the carriage/inclusion of intrinsic and extrinsic camera properties in HEIF. However, CDAM1 allows storage of pinhole camera parameters and define the formula to utilize those parameters, but do not cover other camera distortions and do not account for the EP change(s).

In ISO/IEC 23008-12 2nd Edition CDAM1, the syntax of intrinsic camera properties is specified using the Syntactic Description Language of ISO/IEC 14496-1 as follows:

```
aligned(8) class CameraIntrinsicsMatrix
extends ItemFullProperty(‘cmin’, version = 0, flags) {
  signed int(32) focal_length_x;
  signed int(32) principal_point_x;
  signed int(32) principal_point_y;
  if (flags & 1) {
    signed int(32) focal_length_y;
    signed int(32) skew_factor;
  }
}
```

The CameraIntrinsicsMatrix descriptive item property allows writers to communicate the characteristics of the camera that captured the associated image item. One general form of specifying the intrinsics matrix for a pinhole camera is as follows:

TABLE 1

| fₓ | s | cₓ |
|---|---|---|
| 0 | f_{y} | c_{y} |
| 0 | 0 | 1 |

where
fₓ: horizontal focal length
f_{y}: vertical focal length
s: skew factor
cₓ: principal point x
c_{y}: principal point y

For some cameras, pixels are square and there is no skew. This corresponds to s being zero and fₓ being equal to f_{y}.

The flags field of the CameraIntrinsicsMatrix full property is used to define the values of denominator and skew denominator.

The variable denominator is set equal to (1<<denominatorShiftOperand) where denominatorShiftOperand is equal to ((flags & 0x001F00)>>8).

The variable skewDenominator is set equal to (1<<skewDenominatorShiftOperand) where skewDenominatorShiftOperand is equal to ((flags & 0x1F0000)>>16).

(flags & 1) equal to 0 indicates that simplified intrinsics (no skew, square pixels) are used. (flags & 1) equal to 1 indicates that full intrinsics are used.

focal_length_x specifies the horizontal focal length of the camera in image widths.

focal_length_y specifies the vertical focal length of the camera in image heights. When not present, the value shall be implied to be focal_length_x*image_width÷image_height.

principal_point_x specifies the principal_point_x-coordinate in image widths.

principal_point_y specifies the principal_point_y-coordinate in image heights.

skew_factor specifies the camera system skew factor. When not present its value shall be implied to be 0.

The values of the above intrinsics matrix may be calculated as follows:

fₓ=focal_length_x×image_width/denominator

f_{y}=focal_length_y×image_height/denominator

cₓ=principal_point_x×image_width/denominator

c_{y}=principal_point_y×image_height/denominator

s=skew_factor/skewDenominator
where image_width and image_height come from the ImageSpatialExtentsProperty associated with the image item.

A technical effect of example embodiments of the present disclosure may be to allow seamless compatibility to HEIF, for example by simplifying the EP parameter(s) further so that they can be used on a classical pinhole model present in HEIF. A technical effect of example embodiments of the present disclosure may be to make it possible to model EP as part of regular popular distortion(s), such as radial and tangential distortions.

Example embodiments of the present disclosure may provide implementation for mapping and distortion removal under HEIF.

Example embodiments of the present disclosure may show how to store and signal the estimated EP parameters in the HEIF specification context. Example embodiments of the present disclosure may include a distortion removal operation that may have the technical effect of ensuring good mapping between 3D coordinates and 2D image projections. In an example embodiment, the entrance pupil parameters and radial and tangential distortions may be integrated into the HEIF-related specifications as, for example, supplementary parameter(s). In an example embodiment, these parameters may (eventually) be used for correction of lens distortion introduced in the image formed by the camera lenses due to varying entrance pupil and other forms of distortion(s). A technical effect of the inclusion of these parameters may be to allow proper signaling of their use in the data structure and/or file format.

In an example embodiment, the EP image formulation model described above may be extended for HEIF application. A technical effect of example embodiments of the present disclosure may be to change the effect of the EP image formulation. In an example embodiment, the same coefficients in equation (1) may be retained, but formulated differently. In an example embodiment, a normalization factor d̅ may be included in the EP image formulation model. The normalization factor may be used to transform from world coordinates to image coordinates, may be considered a transform metric, and/or may define a “normalized coordinate” metric and/or pixel coordinate metric, for example in some defined hyperplane. A technical effect of example embodiments of the present disclosure may be to resolve the EP distortion together as part of all other distortion(s) (e.g. radial and tangential distortions) in an iterative end-to-end simplification.

In an example embodiment, the previous equation (1) may be adapted as in equations (3-4). In an example embodiment, equation (1) may be simplified by introducing normalized EP function e(θ), which is directly expressed on the focal length f:

$$\begin{matrix}[ \begin{matrix}{X}_{c} \\ {Y}_{c} \\ {Z}_{c}\end{matrix} ] = [ R T ] [ \begin{matrix}X \\ Y \\ Z \\ 1\end{matrix} ] & ( 3 ) \\ [ \begin{matrix}x \\ y \\ 1\end{matrix} ] = [ \begin{matrix}f + e ( θ ) & 0 & 0 \\ 0 & f + e ( θ ) & 0 \\ 0 & 0 & 1\end{matrix} ] [ \begin{matrix}{X}_{c} \\ {Y}_{c} \\ {Z}_{c}\end{matrix} ] & ( 4 ) \\ [ \begin{matrix}u \\ v \\ 1\end{matrix} ] = [ \begin{matrix}f + e ( θ ) / {s}_{x} & 0 & {c}_{x} \\ 0 & f + e ( θ ) / {s}_{y} & {c}_{y} \\ 0 & 0 & 1\end{matrix} ] [ \begin{matrix}x \\ y \\ 1\end{matrix} ] & ( 5 )\end{matrix}$$

where e(θ) is a normalized entrance pupil parameter, as represented in equation 6. sₓ and s_{y} are the pixel sizes in pixels on x, y-axes, respectively. Their values may be available from a manufacturer of a camera device. Rotation R and Translation T are extrinsic parameters that are used to transform world point P(X,Y,Z) to camera coordinate point P_{c}(X_{c},Y_{c},Z_{c}), and f is the focal length. d̅ is a normalized coefficient, which is determined from radial distance, as shown in equation 7, where ∥.∥ represents a normalized radial distance on x, y, respectively. In addition, from the equation can be deduced as x=f+e(θ)·X_{c}/Z_{c}.

e(θ)=e1*θ₁³+e2*θ₁⁵+e3*θ₁⁷+e4*θ₁⁹+e5*θ₁¹¹/d̅ (6)

d̅=∥x²+y²∥ (7)

Under the HEIF standard, in an example embodiment these EP parameter coefficients may be integrated as part of a data structure comprising intrinsic camera parameters (e.g., CameraIntrinsicsMatrix as described above) or in a supplementary data structure that is associated with an image item or with a data structure comprising intrinsic camera parameters. This may have the technical effect of improving mapping operations and other image formation tasks. In an example embodiment, such measurements may be usable inside the HEIF, and as part of a structure that enables proper signaling. In an example embodiment, distortion may be modeled and simplified in an iterative operation pass. In another example embodiment, radial and tangential distortion may also be part of HEIF. Including radial and tangential distortion in a data structure of HEIF may be required for large, distorted lenses.

In an example embodiment, iterative refinement of the lens distortions (i.e radial, tangential and EP) may be performed for distortion removal (i.e transform distorted pixels to undistorted one). In an example embodiment, an intermediate projection that is free from distortions may be used, such as a fronto-parallel projection, described in Scheimpflug Camera Calibration Using Lens Distortion Model Peter Fasogbon, Luc Duvieubourg and Ludovic Macaire and A. Datta, J. S. Kim, T. Kanade “Accurate Camera Calibration using Iterative Refinement of Control Points”, ICCV 2009. In an example embodiment, a fronto-parallel projection may be used in the distortion removal in the captured image(s).

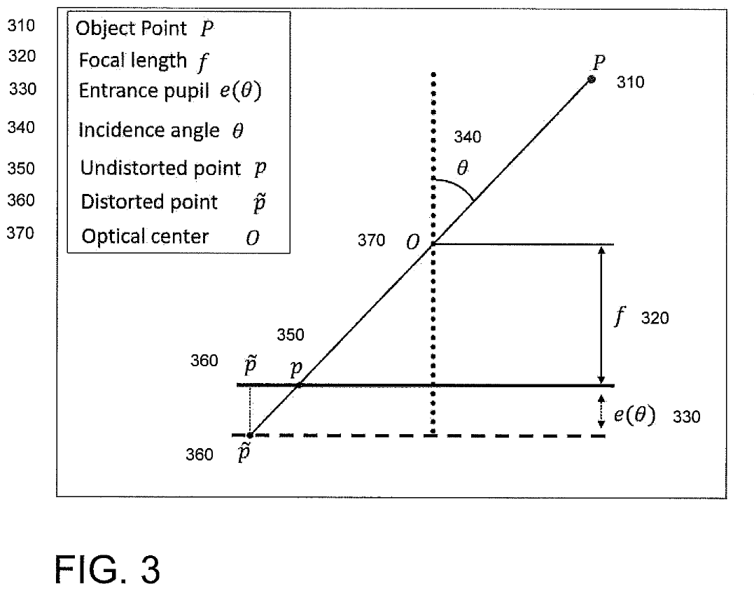

Referring now to FIG. 3, illustrated is an example of application of the image formation model proposed in equations 3-6. The object point P (310) may be projected by “the optical center O (370) to a distorted \tilde{p} (360) at a focal length f (320) and incidence angle θ (340). The entrance pupil incidence correction may be directly simplified on the focal length f (320) using EP e(θ) (330) to transform the undistorted point p (350) to the distorted \tilde{p} (360), and vice versa. In an example embodiment, this simplification may form the basis for iterative distortion removal.

Under non-single viewpoint (NSVP), presented in P. Fasogbon, E. Aksu, “CALIBRATION OF FISHEYE CAMERA USING ENTRANCE PUPIL”, IEEE ICIP, 2019, the incidence angle θ with the optical center O may be calculated easily from camera coordinates (e.g. P_{c}) as in equation 8:

$${θ}_{1} = acos ( \frac{{z}_{c}^{( 1 )}}{\overline{{O}^{( 1 )} {P}_{c}^{( 1 )}}} ) \qquad ( 8 )$$

It may be noted that an initial camera R, T parameters may be used to transform point P to P_{c} in order to estimate θ₁.

In equation 8, θ₁ represents the incidence angle for a world point P⁽ⁱ⁾. In an example embodiment, the calibration procedure may follow the approach in P. Fasogbon, E. Aksu, “CALIBRATION OF FISHEYE CAMERA USING ENTRANCE PUPIL”, IEEE ICIP, 2019 to extract the EP coefficients {e1,e2 . . . eN}. Additionally or alternatively, the radial {k1, k2 . . . kN} and/or the tangential {t1, . . . tN} distortion parameters may be provided.

In an example embodiment, initial EP parameter(s) may be required, and may be provided by camera calibration, for example as in P. Fasogbon, E. Aksu, “CALIBRATION OF FISHEYE CAMERA USING ENTRANCE PUPIL”, IEEE ICIP, 2019.

In an example embodiment, the radial and tangential distortions may be set to zero.

For distortion simplification (i.e addition or removal), in an example embodiment, fronto-parallel projection may be incorporated to refine EP parameters under the proposed model in equations 3-6. In an example embodiment, an image undistort/correction/distortion removal method may use iterative refinement of fronto-parallel control points. During an optimization process, the fronto-parallel image transformation may consist of creating an intermediate image that is free from distortions (i.e. visibly/visually, images that looks like the image plane may be orthogonal to the optical axis of the camera). This resulting image may be free from distortions, and may be used to provide accurate feature detection required to optimize, further, the EP parameter(s) and other lens distortion(s). The idea of fronto-parallel projection has been used in camera calibration tasks, for example as in Scheimpflug Camera Calibration Using Lens Distortion Model Peter Fasogbon, Luc Duvieubourg and Ludovic Macaire; A. Datta, J. S. Kim, T. Kanade “Accurate Camera Calibration using Iterative Refinement of Control Points”, ICCV 2009.

In an example embodiment, distortion removal may comprise an initial calibration phase and a distortion simplification phase.

In an example embodiment, initial calibration may be performed based on an image acquired with a camera, estimated camera parameters, and entrance pupil coefficients. Additionally or alternatively, the initial calibration may be performed based on radial and/or tangential coefficients. In an example embodiment, radial and/or tangential coefficients may each be known, and/or may be set to zero.

In an example embodiment, an algorithm for distortion simplification may be provided. In an example embodiment, distortion simplification may include detecting control points (known as features). The control points may be image corners, or even some projected calibration patterns in the image, or corners around a projected object in the image. In an example embodiment, distortion simplification may include parameter fitting; for example the detected control points may be used to refine the distortion parameter(s) using, for example, Levenberg-Marquardt (see, e.g., P. Fasogbon, E. Aksu, “CALIBRATION OF FISHEYE CAMERA USING ENTRANCE PUPIL”, IEEE ICIP, 2019). In an example embodiment, refining the distortion parameter(s) using the detected control points may be looped/repeated until convergence is achieved. Convergence may be achieved by using reprojection error between distorted point(s) and reprojected point(s) using distortion simplification according to an example embodiment of the present disclosure. Reprojection error on the fronto-parallel image that is free of distortion may be used as an indication of convergence. In an example embodiment, the camera parameter(s) and the lens distortion parameter(s) may be used to undistort and unproject input images to a canonical pattern (e.g. fronto-parallel projection). In an example embodiment, the image may be interpolated to create a frontal image of the fronto-parallel projection. In an example embodiment, (substantially) distortion-free feature pixels (or control points) may be extracted from these frontal images. In an example embodiment, the control points/pixels may be projected, using the estimated camera parameters, back to the distorted image plane. In an example embodiment, the projected control points may be used to refine/fit the lens distortion(s) and entrance pupil parameter(s) using, for example, Levenberg-Marquardt.

In an example embodiment, the EP parameter(s) may include, at least, a normalized factor d̅. In an example embodiment, simplification may be performed with regard to distortion in an image.

A technical effect of considering the Entrance Pupil deviation may be to ensure that pixels located at the highly distorted extremities of the lens are corrected. A technical effect of example embodiments of the present disclosure may be to improve subsequent reconstructed 3D and HEIF operations and mappings.

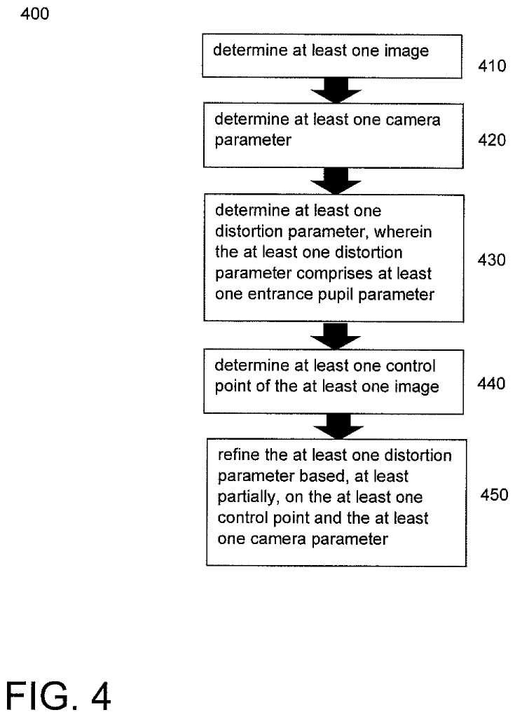

FIG. 4 illustrates the potential steps of an example method 400. The example method 400 may include: determining at least one image, 410; determining at least one camera parameter, 420; determining at least one distortion parameter, wherein the at least one distortion parameter comprises at least one entrance pupil parameter, 430; determining at least one control point of the at least one image, 440; and refining the at least one distortion parameter based, at least partially, on the at least one control point and the at least one camera parameter, 450. The example method may be performed, for example, with an encoder.

In accordance with one example embodiment, an apparatus may comprise: at least one processor; and at least one memory including computer program code; the at least one memory and the computer program code configured to, with the at least one processor, cause the apparatus at least to: determine at least one image; determine at least one camera parameter; determine at least one distortion parameter, wherein the at least one distortion parameter comprises at least one entrance pupil parameter; determine at least one control point of the at least one image; and refine the at least one distortion parameter based, at least partially, on the at least one control point and the at least one camera parameter.

The at least one entrance pupil parameter may comprise at least one normalization factor.

Refining the at least one distortion parameter may comprise the example apparatus being further configured to: transform between world coordinates and coordinates of the at least one image based, at least partially, on the at least one normalization factor.

The at least one distortion parameter may further comprise at least one of: at least one radial distortion parameter, or at least one tangential distortion parameter.

The example apparatus may be further configured to at least one of: set the at least one radial distortion parameter to zero, or set the at least one tangential distortion parameter to zero.

The example apparatus may be further configured to: store the at least one refined distortion parameter in a data structure within a high efficiency image file format.

The at least one control point may comprise at least one of: an image corner, a projected calibration pattern, or a corner around a projected object.

the at least one camera parameter may comprise at least one of: a focal length, an incidence angle, an optical center, an extrinsic parameter, or an intrinsic parameter.

The example apparatus may be further configured to: determine whether the at least one refined distortion parameter has reached convergence.

Refining the at least one distortion parameter may comprise the example apparatus being configured to: undistort and unproject the at least one image to a canonical pattern based, at least partially, on the at least one camera parameter and the at least one distortion parameter; interpolate the at least one image based, at least partially, on the at least one fronto-parallel projection to generate at least one frontal image; extract at least one second control point from the at least one frontal image; reproject the at least one second control point to a plane of the at least one image based, at least partially, on the at least one camera parameter; and refine the at least one distortion parameter based, at least partially, on the at least one reprojected second control point.

The canonical pattern may comprise a fronto-parallel projection of the at least one image.

Refining the at least one distortion parameter may comprise the example apparatus being configured to: refine the at least one distortion parameter using a Levenberg-Marquardt procedure.

The example apparatus may be further configured to: generate an undistorted image based, at least partially, on the refined at least one distortion parameter and the at least one camera parameter.

The example apparatus may be further configured to: correct distortion in a camera model based, at least partially, on the refined at least one distortion parameter.

In accordance with one aspect, an example method may be provided comprising: determining, with a device, at least one image; determining at least one camera parameter; determining at least one distortion parameter, wherein the at least one distortion parameter comprises at least one entrance pupil parameter; determining at least one control point of the at least one image; and refining the at least one distortion parameter based, at least partially, on the at least one control point and the at least one camera parameter.

The at least one entrance pupil parameter may comprise at least one normalization factor.

The refining of the at least one distortion parameter may comprise: transforming between world coordinates and coordinates of the at least one image based, at least partially, on the at least one normalization factor.

The at least one distortion parameter may further comprise at least one of: at least one radial distortion parameter, or at least one tangential distortion parameter.

The example method may further comprise at least one of: setting the at least one radial distortion parameter to zero, or setting the at least one tangential distortion parameter to zero.

The example method may further comprise: storing the at least one refined distortion parameter in a data structure within a high efficiency image file format.

The at least one control point may comprise at least one of: an image corner, a projected calibration pattern, or a corner around a projected object.

The at least one camera parameter may comprise at least one of: a focal length, an incidence angle, an optical center, an extrinsic parameter, or an intrinsic parameter.

The example method may further comprise: determining whether the at least one refined distortion parameter has reached convergence.

The refining of the at least one distortion parameter may comprise: undistorting and unprojecting the at least one image to a canonical pattern based, at least partially, on the at least one camera parameter and the at least one distortion parameter; interpolating the at least one image based, at least partially, on the at least one fronto-parallel projection to generate at least one frontal image; extracting at least one second control point from the at least one frontal image; reprojecting the at least one second control point to a plane of the at least one image based, at least partially, on the at least one camera parameter; and refining the at least one distortion parameter based, at least partially, on the at least one reprojected second control point.

The canonical pattern may comprise a fronto-parallel projection of the at least one image.

The refining of the at least one distortion parameter may comprise: refining the at least one distortion parameter using a Levenberg-Marquardt procedure.

The example method may further comprise: generating an undistorted image based, at least partially, on the refined at least one distortion parameter and the at least one camera parameter.

The example method may further comprise: correcting distortion in a camera model based, at least partially, on the refined at least one distortion parameter.

In an example embodiment, the carriage of camera intrinsic properties may be extended from the definition as specified in (CDAM1, MDS21461_WG03_N00568):

```
aligned(8) class CameraIntrinsicsMatrix
extends ItemFullProperty (‘cmin’, version = 0, flags)
  unsigned int(8) distortion_type;
  if(distortion_type == 1) { // pinhole camera
  signed int(32) focal_length_x;
  signed int(32) principal_point_x;
  signed int(32) principal_point_y;
  if (flags & 1) {
    signed int(32) focal_length_y;
    signed int(32) skew_factor;
  }
  }
//Entrance pupil coefficient
  if(distortion_type == 2) { // Entrance pupil
coefficient
      unsigned int(16) num_ep_coeffs;
      for (int j=0; j<num_ep_coeffs; j++)
        signed int(32) ep_coeff;
  }
//Radial distortion coefficient
  if(distortion_type == 3) {
      unsigned int(16) num_rd_coeffs;
      for (int j=0; j<num_rd_coeffs; j++)
        signed int(32) rd_coeff;
  }
//Tangential distortion coefficient
  if(distortion_type == 4) {
      unsigned int(16) num_td_coeffs;
      for (int j=0; j<num_td_coeffs; j++)
        signed int(32) td_coeff;
  }
}
```

In an example embodiment, the semantics of the parameters in the CameraIntrinsicsMatrix may be as follows.

In an example embodiment, distortion_type may indicate the distortion type of the camera model. The following values may be identified. When distortion_type is equal to 1, the pinhole camera model may be considered. When distortion_type is equal to 2 the entrance pupil model distortion may be considered. When distortion_type is equal to 3, the radial distortion model may be considered. When distortion_type is equal to 4 the tangential distortion model may be considered. It may be noted that these are non-limiting examples.

In an example embodiment, num_ep_coeffs may specify the number of entrance pupil coefficients for the circular image. The value of num_ep_coeffs may be equal to 3, 5, 7, or 9, and other values of num_ep_coeffs that may be reserved.

In an embodiment, the instances of ep_coeff may be entrance pupil distortion parameters as defined above.

In an example embodiment, num_rd_coeffs may specify the number of radial distortion coefficients for the circular image.

In an embodiment, the instances of rd_coeff may be radial distortion parameters.

In an example embodiment, num_td_coeffs may specify the number of tangential distortion coefficients for the circular image.

In an embodiment, the instances of td_coeff may be tangential distortion parameters.

In accordance with one example embodiment, an apparatus may comprise: circuitry configured to perform: determine at least one image; determine at least one camera parameter; determine at least one distortion parameter, wherein the at least one distortion parameter comprises at least one entrance pupil parameter; determine at least one control point of the at least one image; and refine the at least one distortion parameter based, at least partially, on the at least one control point and the at least one camera parameter.

In accordance with one example embodiment, an apparatus may comprise: processing circuitry; memory circuitry including computer program code, the memory circuitry and the computer program code configured to, with the processing circuitry, enable the apparatus to: determine at least one image; determine at least one camera parameter; determine at least one distortion parameter, wherein the at least one distortion parameter comprises at least one entrance pupil parameter; determine at least one control point of the at least one image; and refine the at least one distortion parameter based, at least partially, on the at least one control point and the at least one camera parameter.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: determining at least one image; determining at least one camera parameter; determining at least one distortion parameter, wherein the at least one distortion parameter comprises at least one entrance pupil parameter; determining at least one control point of the at least one image; and refining the at least one distortion parameter based, at least partially, on the at least one control point and the at least one camera parameter.

The at least one entrance pupil parameter may comprise at least one normalization factor.

The means configured to perform refining of the at least one distortion parameter may comprise means configured to perform: transforming between world coordinates and coordinates of the at least one image based, at least partially, on the at least one normalization factor.

The at least one distortion parameter may further comprise at least one of: at least one radial distortion parameter, or at least one tangential distortion parameter.

The means may be further configured to perform at least one of: setting the at least one radial distortion parameter to zero, or setting the at least one tangential distortion parameter to zero.

The means may be further configured to perform: storing the at least one refined distortion parameter in a data structure within a high efficiency image file format.

The at least one control point may comprise at least one of: an image corner, a projected calibration pattern, or a corner around a projected object.

The at least one camera parameter may comprise at least one of: a focal length, an incidence angle, an optical center, an extrinsic parameter, or an intrinsic parameter.

The means may be further configured to perform: determining whether the at least one refined distortion parameter has reached convergence.

The configured to perform refining of the at least one distortion parameter may comprise means configured to perform: undistorting and unprojecting the at least one image to a canonical pattern based, at least partially, on the at least one camera parameter and the at least one distortion parameter; interpolating the at least one image based, at least partially, on the at least one fronto-parallel projection to generate at least one frontal image; extracting at least one second control point from the at least one frontal image; reprojecting the at least one second control point to a plane of the at least one image based, at least partially, on the at least one camera parameter; and refining the at least one distortion parameter based, at least partially, on the at least one reprojected second control point.

The canonical pattern may comprise a fronto-parallel projection of the at least one image.

The means configured to perform refining of the at least one distortion parameter may comprise means configured to perform: refining the at least one distortion parameter using a Levenberg-Marquardt procedure.

The means may be further configured to perform: generating an undistorted image based, at least partially, on the refined at least one distortion parameter and the at least one camera parameter.

The means may be further configured to perform: correcting distortion in a camera model based, at least partially, on the refined at least one distortion parameter.

In accordance with one example embodiment, a non-transitory computer-readable medium comprising program instructions stored thereon which, when executed with at least one processor, cause the at least one processor to: determine at least one image; determine at least one camera parameter; determine at least one distortion parameter, wherein the at least one distortion parameter comprises at least one entrance pupil parameter; determine at least one control point of the at least one image; and cause refining of the at least one distortion parameter based, at least partially, on the at least one control point and the at least one camera parameter.

The example non-transitory computer-readable medium may be further configured to: perform a method according to an example embodiment of the present disclosure.

In accordance with another example embodiment, a non-transitory program storage device readable by a machine may be provided, tangibly embodying a program of instructions executable by the machine for performing operations, the operations comprising: determine at least one image; determine at least one camera parameter; determine at least one distortion parameter, wherein the at least one distortion parameter comprises at least one entrance pupil parameter; determine at least one control point of the at least one image; and cause refining of the at least one distortion parameter based, at least partially, on the at least one control point and the at least one camera parameter.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment, features can be all in pixels and/or some metric units. Accordingly, the description is intended to embrace all such alternatives, modification and variances which fall within the scope of the appended claims.

1. An apparatus comprising:
at least one processor; and
at least one non-transitory memory including computer program code;
the at least one memory and the computer program code configured to, with the at least one processor, cause the apparatus at least to:
determine at least one image;
determine at least one camera parameter;
determine at least one distortion parameter, wherein the at least one distortion parameter comprises at least one entrance pupil parameter;
determine at least one control point of the at least one image; and
refine the at least one distortion parameter based, at least partially, on the at least one control point and the at least one camera parameter.

2. The apparatus of claim 1, wherein the at least one entrance pupil parameter comprises at least one normalization factor.

3. The apparatus of claim 2, wherein refining the at least one distortion parameter comprises the at least one memory and the computer program code are configured to, with the at least one processor, cause the apparatus to:
transform between world coordinates and coordinates of the at least one image based, at least partially, on the at least one normalization factor.

4. The apparatus of claim 1, wherein the at least one distortion parameter further comprises at least one of:
at least one entrance pupil distortion parameter,
at least one radial distortion parameter, or
at least one tangential distortion parameter.

5-6. (canceled)

7. The apparatus of claim 1, wherein the at least one control point comprises at least one of:
an image corner feature in pixels,
an image projection of a calibration pattern, or
a corner pixel around a projected object.

8. The apparatus of claim 1, wherein the at least one camera parameter comprises at least one of:
a focal length,
an incidence angle,
an optical center,
an entrance pupil distortion coefficient,
an entrance pupil distortion parameter,
an extrinsic parameter, or
an intrinsic parameter.

9. The apparatus of claim 1, wherein the at least one memory and the computer program code are configured to, with the at least one processor, cause the apparatus to:
determine whether the at least one refined distortion parameter has reached convergence.

10. The apparatus of claim 1, wherein refining the at least one distortion parameter comprises the at least one memory and the computer program code are configured to, with the at least one processor, cause the apparatus to:
undistort and unproject the at least one image to a canonical pattern based, at least partially, on the at least one camera parameter and the at least one distortion parameter;
interpolate the at least one image based, at least partially, on at least one fronto-parallel projection to generate at least one frontal image;
extract at least one second control point from the at least one frontal image;
reproject the at least one second control point to a plane of the at least one image based, at least partially, on the at least one camera parameter; and
refine the at least one distortion parameter based, at least partially, on the at least one reprojected second control point.

11-12. (canceled)

13. The apparatus of claim 1, wherein the at least one memory and the computer program code are configured to, with the at least one processor, cause the apparatus to:
generate an undistorted image based, at least partially, on the at least one refined distortion parameter and the at least one camera parameter.

14. The apparatus of claim 1, wherein the at least one memory and the computer program code are configured to, with the at least one processor, cause the apparatus to:
correct distortion in a camera model based, at least partially, on the at least one refined distortion parameter.

15. A method comprising:
determining, with a device, at least one image;
determining at least one camera parameter;
determining at least one distortion parameter, wherein the at least one distortion parameter comprises at least one entrance pupil parameter;
determining at least one control point of the at least one image; and
refining the at least one distortion parameter based, at least partially, on the at least one control point and the at least one camera parameter.

16. The method of claim 15, wherein the at least one entrance pupil parameter comprises at least one normalization factor.

17. The method of claim 16, wherein the refining of the at least one distortion parameter comprises:
transforming between world coordinates and coordinates of the at least one image based, at least partially, on the at least one normalization factor.

18. The method of claim 15, wherein the at least one distortion parameter further comprises at least one of:
at least one entrance pupil distortion parameter,
at least one radial distortion parameter, or
at least one tangential distortion parameter.

19-20. (canceled)

21. The method of claim 15, wherein the at least one control point comprises at least one of:
an image corner feature in pixels,
an image projection of a calibration pattern, or
a corner pixel around a projected object.

22. The method of claim 15, wherein the at least one camera parameter comprises at least one of:
a focal length,
an incidence angle,
an optical center,
an entrance pupil distortion coefficient,
an entrance pupil distortion parameter,
an extrinsic parameter, or
an intrinsic parameter.

23. (canceled)

24. The method of claim 15, wherein the refining of the at least one distortion parameter comprises:
undistorting and unprojecting the at least one image to a canonical pattern based, at least partially, on the at least one camera parameter and the at least one distortion parameter;
interpolating the at least one image based, at least partially, on at least one fronto-parallel projection to generate at least one frontal image;
extracting at least one second control point from the at least one frontal image;
reprojecting the at least one second control point to a plane of the at least one image based, at least partially, on the at least one camera parameter; and
refining the at least one distortion parameter based, at least partially, on the at least one reprojected second control point.

25-26. (canceled)

27. The method of claim 15, further comprising:
generating an undistorted image based, at least partially, on the at least one refined distortion parameter and the at least one camera parameter.

28. The method of claim 15, further comprising:
correcting distortion in a camera model based, at least partially, on the at least one refined distortion parameter.

29-42. (canceled)

43. A non-transitory computer-readable medium comprising program instructions stored thereon which, when executed with at least one processor, cause the at least one processor to:
determine at least one image;
determine at least one camera parameter;
determine at least one distortion parameter, wherein the at least one distortion parameter comprises at least one entrance pupil parameter;
determine at least one control point of the at least one image; and
cause refining of the at least one distortion parameter based, at least partially, on the at least one control point and the at least one camera parameter.
